(19) United States
(12) Patent Application Publication
(10) Pub. No.: US 2004/0163749 A1
(43) Pub. Date: Aug. 26, 2004

(54) Method and manufacturer for producing mosaic, using a pattern consisting of multiple piece-segregated patterns underneath a transparent mosaic base

(76) Inventor: Gerrit Leendert Verschoor, Amsterdam (NL)

Correspondence Address: Angenehm Law Firm, Ltd., P.O. Box 48755, Coon Rapids, MN, 55448-0755, US

(21) Appl. No.: 10/367,454

(22) Filed: Feb. 14, 2003

(51) Int. Cl. B44C 1/00

(52) U.S. Cl. 156/63; 428/49

(57) ABSTRACT

Method and manufacturer for producing mosaic, using a pattern consisting of multiple piece-segregated patterns underneath a single or multiple transparent or translucent mosaic bases. Technical field: Production or assembly of mosaic. In order to produce a mosaic reproduction of an image or (graphic) design, a pattern is required, which pattern requires accurate reading and record keeping. The invention introduces a method of producing a mosaic reproduction in conjunction with a transparent or translucent mosaic mounting base wherein a piece-segregated pattern (41) is placed underneath the said (30) base. The invention further introduces a manufacturer: A mosaic mounting base. Drawing A depicts the principle of piece-segregated patterns. Drawing B depicts examples of the said patterns. Drawing C, D and E depict the invented manufacturer (30). Drawing F and G depict the positioning of the said pattern under the said base. Intended use of the invention is in (home) crafts.

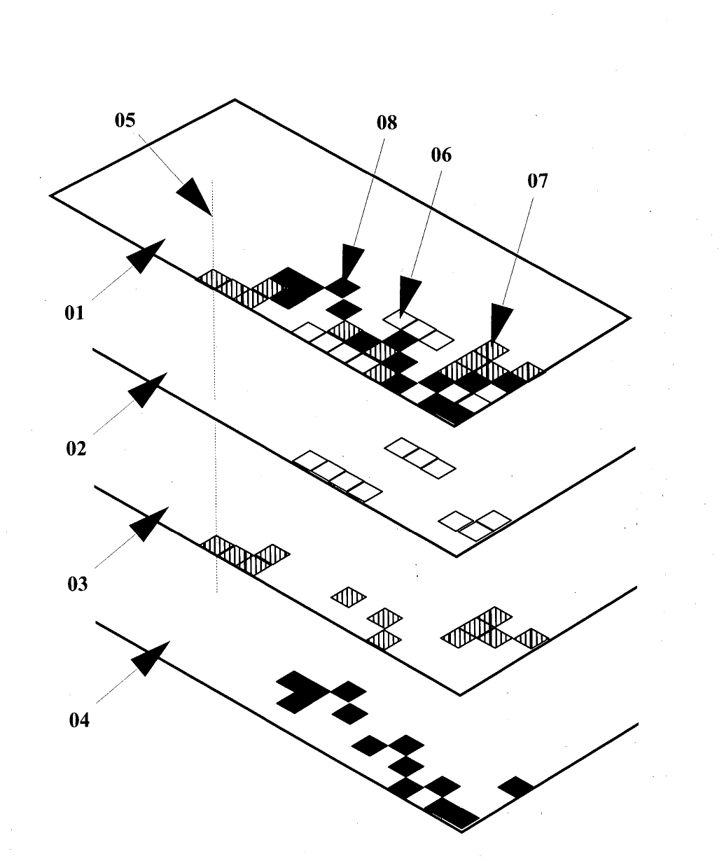

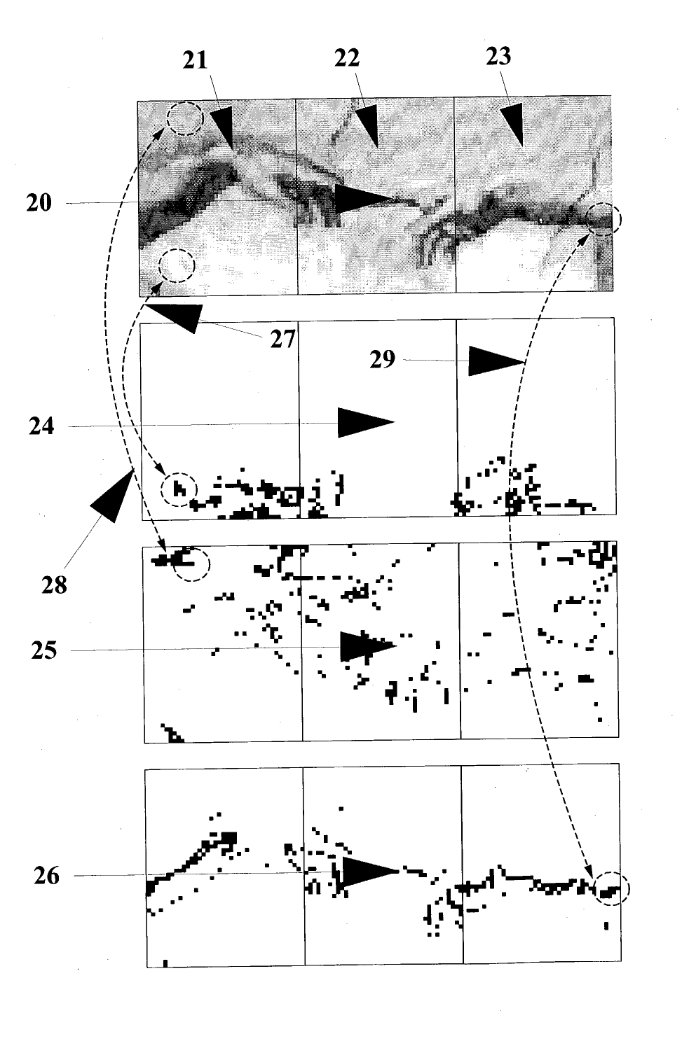

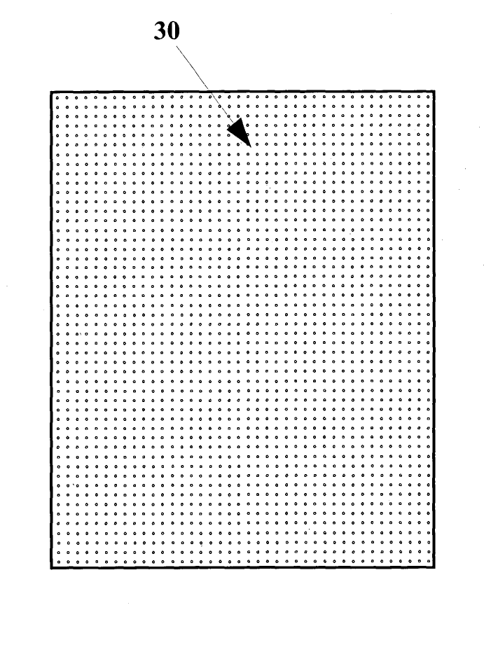

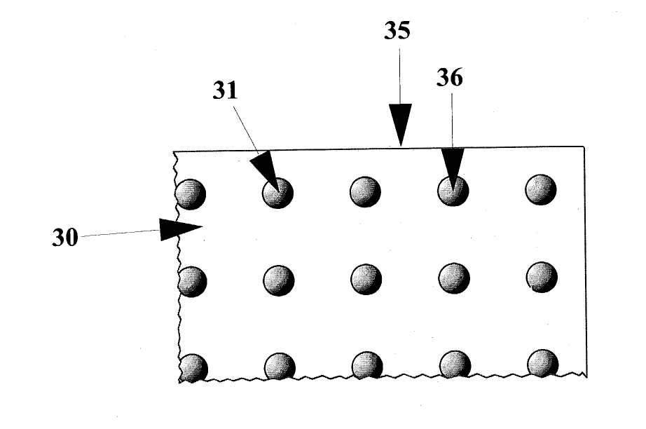

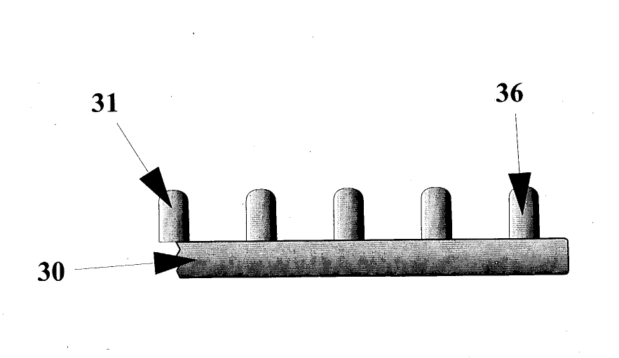

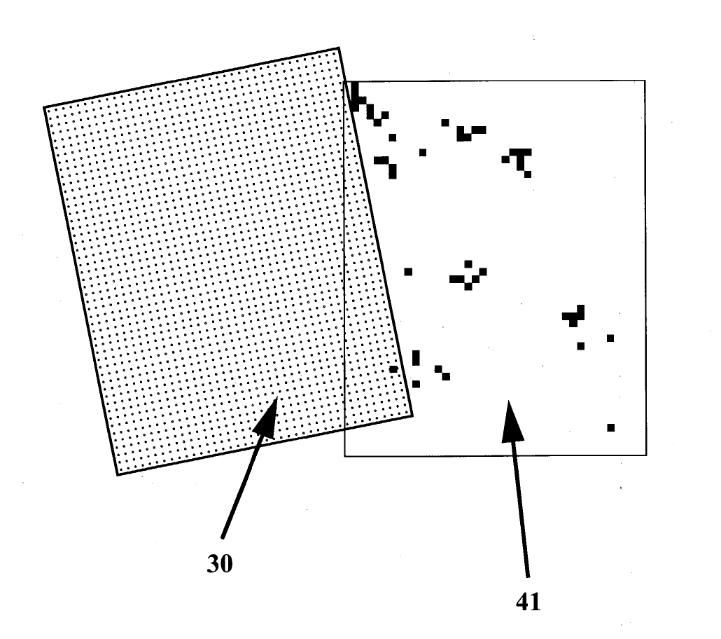

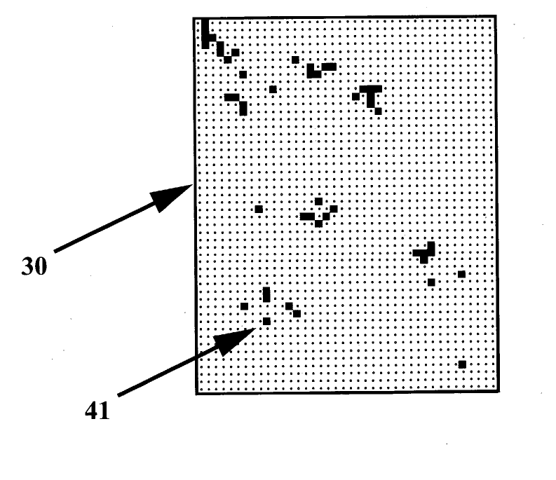

Method and manufacturer for producing mosaic, using a pattern consisting of multiple piece-segregated patterns underneath a transparent mosaic base.

### TECHNICAL FIELD

Production of a mosaic reproduction of an image or (graphic) design.

### BACKGROUND ART

History of Mosaic

Mosaics have been present since, at least, 5000 BC. Fine examples date back to the ancient cultures of the Sumarians of Asia Minor, the Pre-Colombian culture of Mexico, the Greco-Roman culture.

Patterns for Mosaics

In order to produce a mosaic reproduction of an image or (graphic) design, one requires a pattern which allows an artisan to reproduce a specific image or design in mosaic. There are numerous and well established ways to display a pattern. The two most common methods are:

“Method A”: A pattern, commonly printed on one or more sheets of paper, carrying a full-size or scaled schematic pattern of a mosaic. Individual mosaic pieces are represented graphically or in text, in such a way that an artisan receives instruction both on which piece to place (size, form, shape, color, texture, etc.) and where to place it. An artisan studies a pattern, selects a mosaic piece to be added to a mosaic, places it on a mosaic art (with or without using a template or mould) and, optionally, updates a pattern with a record of placement. Prior art examples: Netherlands Patent Application NL-A-6709548 and NL-A-6709549.

“Method B”: A pattern similar to “Method A” described above, where—in this method—an artisan produces a mosaic on top of a pattern, covering a pattern piece by piece. Prior art example: Netherlands Patent 6806157.

Known prior art share a requirement for an artisan to extract mosaic piece placement instructions from a pattern. In the method deploying a separate pattern or patterns (Method A), in order to produce a patterned design, an artisan needs to carefully track which pieces have been placed and which pieces still await placement. The method in which a mosaic is produced on top of a pattern (Method B) only shows those piece placement instructions pertaining to pieces still awaiting placement.

The intended mode of usage of the invention is in the (home) crafts sector. In this sector the brand “Ministeck” is well known (reference: www.ministeck.de). The Ministeck concept of producing mosaic has been employed by many alternate suppliers of this (home) crafts mosaic product. Ministeck deploys pattern “Method A” described above.

What is needed is a method of producing mosaic using patterns, where the requirement for accurate reading of patterns and record keeping have been removed.

Mosaic Base

Mosaic has been constructed using countless combinations of materials, forms and shapes, colors, textures and undergrounds. In the (home) crafts field a (synthetic) mosaic mounting base, consisting of a net with small meshes, is common. Such mosaic mounting base is used in conjunction with a (synthetic) mosaic piece carrying a single short pin at its underside. A mosaic piece can be mounted onto the said base by pushing a mosaic piece's short pin into a mesh. A reverse type is also used. In such a type, the base consists of pins, and the mosaic pieces feature holes. Individual mosaic pieces are mounted onto the pins. Other types of bases are used. For example, a magnetic base used in conjunction with mosaic pieces containing metal (or reverse, where a mosaic piece is magnetic and a mosaic mounting base contains metal). Or, a mosaic mounting base with pins used in combination with tubular mosaic pieces, where a single tubular mosaic piece fits around a pin. The aforementioned prior art examples Netherlands Patent Application NL-A-6709548, NL-A-6709549 and Netherlands Patent 6806157 provide examples, as does the well known brand “Ministeck” (reference: www.ministeck.de). Prior art mosaic bases require accurate reading of patterns and record keeping.

What is needed is a mosaic mounting base which removes the requirement for accurate reading of patterns and record keeping

### DISCLOSURE OF INVENTION

Definitions.

The Oxford Dictionary defines “Mosaic” as follows: “The form or work of art in which pictures etc. are produced of glass, stone, etc., of different colors.” “Mosaic” in the following description, claims and abstract texts applies to any form or work of art in which pictures, texts or images etc. are produced of individual mosaic pieces of glass, stone, synthetic, fabric, etc., of different size and/or shape and/or color and/or texture.

“Mosaic mounting base” in the following description, claims and abstract texts applies to a surface onto which “mosaic pieces” can be fixed, applied or mounted. It further applies to a surface onto which “mosaic pieces” can be temporarily placed and/or fixed and/or mounted, awaiting permanent joining together and/or fixing and/or mounting onto another surface by use of any available technique. “Mosaic piece” in the following description, claims and abstract texts applies to a material piece or substance of any specific size and/or shape and/or color and/or texture, which can be used in a mosaic. It further applies to color paint and/or drawing and/or etching and/or other technique used to temporarily or durable mark a transparent or translucent underground or mosaic base.

“Mosaic piece option” in the following description, claims and abstract texts applies to a specific set or collection of identical, unique or distinct “mosaic pieces”. Example: All mosaic pieces of a specific size and specific shape and specific CMYK color and specific texture constitute one “mosaic piece option.”

“Piece-segregated pattern” in the following description, claims and abstract texts applies to a pattern used in the production of a mosaic reproduction of an image or (graphic) design, that graphically displays the mosaic piece positions, in full-scale, of a specific mosaic piece option or set of mosaic piece options only. It also applies to a set, complete or in part, of individual piece-segregated patterns, together forming a pattern required for production of a complete or in part mosaic reproduction of an image or (graphic) design.

Technical Problem Described

A mosaic typically consists of any number of individual mosaic pieces and a surface or mosaic mounting base onto which individual mosaic pieces are fixed, applied or mounted.

When an artisan produces a mosaic of a mosaic design, a choice of specific mosaic piece options exist. Example: All mosaic pieces may share size, shape and texture, but differ in color. Mosaic piece options in this example relate to options in color: Black mosaic piece option; White mosaic piece option; Red mosaic piece option; Blue mosaic piece option; etcetera. End of example.

When an artisan desires to produce a mosaic using a pattern or design, he requires to produce or acquire a design consistent with available mosaic piece options. Manual (i.e. without any reference to an existing expression of art or design) production of an original mosaic design is as difficult as any expression of art: It requires artistic skills. Manual production of a mosaic design on the basis of an existing expression of art (an image, painting, drawing, etc.) may require less artistic skills, but is labour-intensive. When an artisan has secured a satisfactory design and mosaic pattern, and accumulated a required mosaic base and mosaic pieces (according to piece options specified by a pattern), actual production of a mosaic can commence. During the actual production of a mosaic, an artisan needs to carefully read a pattern in order to produce a faithful mosaic representation thereof. Demand for careful reading increases with increases in complexity of a mosaic pattern. Complexity is further dependent on resolution: That is, the number of individual mosaic pieces in relation to the surface area of a mosaic. The higher the resolution, the higher the complexity. Hence, the following challenges exist, which challenges increase with an increase in mosaic complexity: How to efficiently produce a mosaic pattern; How to efficiently work with a pattern in such a way that a faithful mosaic representation thereof is produced.

Disclosure; Advantages of Invention Over Prior Art

The invention introduces a method of producing mosaic using piece-segregated patterns, that is one pattern for a specific mosaic piece option, which pattern is placed directly underneath a transparent or translucent mosaic mounting base. A piece-segregated patter graphically displays mosaic piece positions, in full-scale, of a specific mosaic piece option, which positions are directly readable through a transparent or translucent mosaic base. The object of the invention is to dramatically increase the efficiency in the production of pattern-based mosaic.

How this increase in efficiency is attained is described in the following paragraphs, which refer to “Drawings A, B, C, D, E, F and G”.

The invented method differs from prior art in that a mosaic pattern is used which, in fact, consists of multiple piece-segregated patterns: One pattern for a specific mosaic piece option.

The invented mosaic mounting base differs from prior art in that a transparent or translucent mosaic mounting base is used, specifically designed for use with piece-segregated patterns.

The invented method and mosaic mounting base combined result in mosaic production which differs from prior art in that it allows for increases in mosaic production efficiency and increases in attainable mosaic complexity. The next paragraphs explain the method and manufacturer in more detail.

### DESCRIPTION OF THE PREFERRED EMBODIMENTS

Method of Piece-Segregated Patterns Disclosed

“Drawing A” shows a small and simplified portion of mosaic design (01) which is visually presented in the FIGURE as the top layer (01) of four layers (01), (02), (03), (04). This top layer (01), carrying a mosaic design, shows small square mosaic pieces in three colors: White (06); Grey, here depicted as diagonally hatched (07); Black (08). Line (05) demonstrates how the exact mosaic position of the most left grey mosaic piece is transposed from the mosaic design (01) onto the layer (03) which layer exclusively carries the positions of the grey color mosaic pieces. The lower layers (02), (03) and (04) only show the white, grey and black mosaic pieces respectively, positioned at their exact mosaic pattern position. Thus, layer (02) constitutes the piece-segregate mosaic pattern for all “color=white” mosaic pieces (06). Layer (03) constitutes the piece-segregate mosaic pattern for all “color=grey” mosaic pieces (07). Layer (04) constitutes the piece-segregate mosaic pattern for all “color=black” mosaic pieces (08). If a mosaic design carries more colors or piece options, the invented method would produce more layers: One layer for each unique color or mosaic piece option. Alternatively, each layer or piece-segregated pattern could contain several mosaic piece options as long as clarity-of-instruction and readability-of-pattern is not reduced. Typically, when several mosaic piece options are included in a single piece-segregated pattern, the number of mosaic piece options included does not exceed four. “Drawing B” provides an example of the above method. Top image depicts a design (20) of a famous painting by Michelangelo “The Creation of Adam.” The image has been tiled into a mosaic pattern of 120 by 50 pieces (width by height) of a set of mosaic piece options consisting of 25 different grey tones. The three large rectangular squares (21), (22) and (23) each cover an area of 40 by 50 pieces (width by height), which corresponds to a mosaic mounting base disclosed further below (Drawing “C” (30)). This specific mosaic pattern requires the use of three mosaic mounting bases of each 40 by 50 mosaic piece positions, each joined horizontally in portrait orientation.

Image (24) shows the piece-segregated pattern for all pieces of a specific light-grey color, depicting a black small rectangular square at each precise mosaic piece location of that specific light-grey color. For example, dashed line (27) demonstrates the full-scale transposition of some specific light-grey color mosaic piece positions from design (20) onto piece-segregated pattern image (24).

Image (25) shows the piece-segregated pattern for all pieces of a specific mid-grey color, depicting a black small rectangular square at each precise mosaic piece location of that specific mid-grey color. For example, dashed line (28) demonstrates the full-scale transposition of some specific mid-grey color mosaic piece positions from design (20) onto piece-segregated pattern image (25).

Image (26) shows the piece-segregated pattern for all pieces of a specific dark-grey color, depicting a black small rectangular square at each precise mosaic piece location of that specific dark-grey color. For example, dashed line (29) demonstrates the full-scale transposition of some specific dark-grey color mosaic piece positions from design (20) onto piece-segregated pattern image (26).

Each image (24), (25) and (26) further shows three large portrait-oriented rectangular squares, each corresponding to the size of a single mounting base disclosed further below (Drawing “C” (30)). Actual piece-segregated patterns are produced full-size.

An artisan, desiring to produce the mosaic of Michelangelo's painting, depicted on “Drawing B” (20), can now place a transparent or translucent mounting base on top of the left rectangular square of light-grey piece option pattern (24) and place the specific light grey mosaic pieces on top of each black square or pixel. “Drawing F and G” demonstrate how a single transparent mounting base (30) is used in conjunction with a piece-segregated pattern (41). An artisan places transparent mounting base “Drawing F” (30) onto a piece-segregated pattern “Drawing F” (41), until base “Drawing G” (30) precisely fits on top of pattern “Drawing G” (41). The precise fit is depicted at “Drawing G”. An artisan can now visually and unambiguously read which mosaic piece position requires the placement of a mosaic piece. An artisan picks up a specific mosaic piece which correlates with the piece-segregated pattern (41) placed underneath the base (30), and positions it onto the mosaic piece position which carries a black square underneath it on the pattern (41). Each mosaic piece placement subsequently blocks out of sight the underlying black square, making it very easy for the artisan to read which mosaic piece positions still require mosaic piece placement. When a specific piece-segregated pattern (41) is completed, an artisan places the next piece-segregated pattern underneath the base (30) and repeats the steps.

Transparent Mosaic Mounting Base Disclosed

“Drawing C” depicts a top view of a transparent mosaic mounting base (30) full-scale. The dots represent individual mosaic piece placement positions. The base (30) is sized 40 by 50 mosaic piece positions, orderly distributed in rows at equal x-axis and y-axis distance.

“Drawing D” depicts the top right corner of the transparent mosaic mounting base (30) in close up. Here we see the top right fifteen mosaic piece positions, each consisting of a small pin (“Drawing D” (31)=topview; “Drawing E” (31)=sideview).

When mounted on adjacent pins, the pieces form a flush mosaic of square mosaic pieces (when viewed straight from the top). “Drawing E” depicts a side view of the mounting base (30) in close up, depicting the five most right mosaic piece positions, each consisting of a small pin (31).

The transparent mosaic mounting base (30) depicted in “Drawing C, D and E” is constructed of granulate poly carbonate, using injection moulding technology. The transparent mosaic mounting base (30) displayed in “Drawing C, D and E” is sized 101.6×127.0 millimeter. The bottom of the base (30) is completely smooth; All edges are slightly softed or rounded for safe and comfortable handling. The flat surface is 1.3 millimeter thick; Each pin is 1.9 millimeter high and 1.0 millimeter thick. Each pin (31) is straight rod, that is: not tapered. Pin (31) top is round. The shortest distance from the center of each outer edge mosaic position (36) to the nearest base edge (35) equals exactly 50 percent of the x-axis and/or y-axis distance between adjacent pins (31), enabling the production of mosaic reproductions of a surface area in excess of a single mosaic mounting base. When an artisan chooses to produce a mosaic reproduction of a surface area in excess of a single mosaic mounting base, two or more of the said bases can be placed side by side, as depicted in “Drawing B” (21); (22); (23). An artisan can thus finish or complete all individual mosaic mounting bases and subsequently seamlessly join them together, fixing their side by side positions through any preferred means. The principle of design of the displayed mounting base (30) is solely based on the invented method of using piece-segregated patterns underneath a transparent or translucent mosaic piece mounting base. Other mounting base designs compatible with the method are possible. Required injection moulding skills do not exceed those common within the injection moulding industry.

Invented Method Not Restricted to Invented Mosaic Mounting Base

The invented method is not restricted in its application to usage in conjunction with the invented manufacturer, the mosaic mounting base.

A transparent or translucent mounting base may or may not become the (semi-) permanent base or fixture for a mosaic. The invented method can be used in conjunction with three principle types or forms of mosaic bases.

“Type 1—(Semi-) permanent mosaic mounting base”. The invented method of producing mosaic, using piece-segregated patterns underneath a transparent or translucent mosaic mounting base, is used to (semi-) permanently fix mosaic pieces onto a mosaic mounting base. The base becomes a part of the finished mosaic art in the same manner as linen typically forms the base of an oil-painting.

“Type 2—Assembly mosaic mounting base”: The invented method of producing mosaic, using piece-segregated patterns underneath a transparent or translucent mosaic mounting base, is used to initially assemble part or all of the mosaic pieces according to the pattern instructions. The mosaic art can subsequently be (semi-) permanently fixed or mounted using any available technique. This specific usage of producing mosaic, using piece-segregated patterns underneath a transparent or translucent mosaic mounting base, can best be explained by example. “Example A:” A complex stained glass mosaic, constructed by using pieces of hundreds of identical shaped (square) glass mosaic piece options, is initially assembled onto a transparent or translucent mosaic mounting base equipped with a sticky surface which allows for mosaic piece positioning and subsequent correcting. When the mosaic art is completed, the mosaic is sprayed with an adhesive designed to produce permanent fixture, following which the intended permanent mosaic base is permanently fixed onto the mosaic. When the adhesive has succeeded in permanently fixing the pieces onto the permanent mosaic base (e.g. transparent glass), the permanent base is lifted off the transparent or translucent mosaic mounting base on top of which the mosaic was initially produced. The result will be a glass mosaic reproduction of an image or (graphic) design. “Example B:” A complex ceramic tile mosaic, constructed by using pieces of hundreds of identical shaped (square) but uniquely colored ceramic tile piece options is initially assembled onto a transparent or translucent mosaic mounting base equipped with a sticky surface which allows for mosaic piece positioning and subsequent correcting. When the mosaic art is completed, a new temporary base equipped with a mild temporary adhesive is placed onto the mosaic. This temporary base is lifted off the transparent or translucent mosaic mounting base on top of which the mosaic was initially produced. Subsequently, the mosaic—using the temporary base—is transported to e.g. a wall segment covered with ceramic tile fixing or gluing plaster, following which the mosaic is placed onto the wall. The temporary base is removed when the plaster has secured sufficient fixing of the individual tiles. The result will be a ceramic tile mosaic reproduction of an image or (graphic) design.

“Type 3—Application mosaic mounting base”: The invented method of producing mosaic, using piece-segregated patterns underneath a transparent or translucent mosaic mounting base, is used to instruct an artisan where to apply a specific color paint and/or ceramic powder and/or etch mark or other onto a transparent or translucent mounting base.

“Example A:” Glass paint of a specific color can be applied following the position and color instructions of the piece-segregated patterns underneath a transparent or translucent mosaic mounting base. The result will be a pointillism-style mosaic or painting of an image or (graphic) design.

“Example B:” Ceramic powder resulting in a specific color, can be applied following the position and color instructions of the piece-segregated patterns underneath a transparent or translucent mosaic piece glass mounting base. When completed, the glass mounting base could be placed in an oven set at a specific temperature. The result will be a mosaic ceramic reproduction of an image or (graphic) design.

Irrespective of whether a (semi-) permanent type, assembly type or application type mounting base is used in conjunction with the invented method, the advantages over prior art as listed further below.

Other types or forms of bases compatible with the invented method of producing mosaic using piece-segregated patterns underneath a transparent or translucent mosaic mounting base will become apparent from a consideration of the invention description and drawings.

Advantages of the Invented Method Over Prior Art

Prior art methods of producing a mosaic reproduction of an image or (graphic) design, require an artisan to actually read a mosaic pattern and record piece placement progression, where the required form of reading and recording may differ per method used. The difficulty of said reading a recording increases with increases in mosaic complexity, that is: increases in mosaic size and/or number of mosaic piece options. The invented method substantially increases ease of pattern use by substantially reducing the complexity of said reading requirement and by eliminating the said recording requirement. The invented mosaic mounting base provides an efficient manufacturer for use in conjunction with the invented method.

Prior art methods of producing a mosaic reproduction of an image or (graphic) design is, intrinsically, subject to errors in reproduction. Errors occur when an artisan fails to correctly read a pattern and/or fails to correctly record piece placement progression and/or fails to position a mosaic piece at the position instructed in the pattern. Further, the probability a mosaic reproduction increases with increases in mosaic complexity, that is: increases in mosaic size and/or number of mosaic piece options. The invented method uses piece-segregated patterns: Each piece-segregated pattern only depicts placement instructions pertaining one or one specific set of mosaic piece options, whereby the invented method substantially reduces the probability of the said errors.

The invented mosaic mounting base provides an efficient manufacturer for use in conjunction with the invented method.

The combination of all aforementioned advantages of the invented method and invented manufacturer over prior art further result in a synergistic advantage: A reduction in the time required to produce a mosaic reproductions of an image or (graphic) design. This reduction in time required increases with increases in mosaic design complexity.

Other advantages of the method of producing a mosaic reproduction of an image or (graphic) design using piece-segregated patterns underneath transparent or translucent mosaic mounting base will become apparent from a consideration of the invention description and drawings.

Other advantages of the manufacturer, the mosaic mounting base (30), will become apparent from a consideration of the invention description and drawings.

Although the present invention has been described with reference to preferred embodiments, workers skilled in the art will recognize changes may be made in form and detail without departing from the spirit and scope of the invention.

### BRIEF DESCRIPTION OF DRAWINGS

The following paragraphs briefly describe each drawing.

Drawing A

“Drawing A” shows a small and simplified portion of mosaic design (01) which is visually presented in the FIGURE as the top layer (01) of four layers (01), (02), (03), (04).

The top layer (01), carrying the mosaic pattern, shows small square mosaic pieces in three colors: White (06); Grey, here depicted as diagonally hatched (07); Black (08).

Line (05) demonstrates how the exact mosaic position of the most left grey mosaic piece is transposed onto the layer (03) which layer exclusively carries the positions of the grey color mosaic pieces.

The lower layers (02), (03) and (04) only show the white, grey and black mosaic pieces respectively, positioned at their exact mosaic pattern position.

Layer (02) depicts the piece-segregate mosaic pattern for all “color=white” mosaic pieces (06).

Layer (03) depicts the piece-segregate mosaic pattern for all “color=grey” mosaic pieces (07).

Layer (04) depicts the piece-segregate mosaic pattern for all “color=black” mosaic pieces (08).

Drawing B

“Drawing B” shows four images (top to bottom). The images are depicted smaller than full-scale.

Top image (20) depicts a detail of a famous painting by Michelangelo “The Creation of Adam.” The image has been tiled into a mosaic pattern of 120 by 50 pieces (width by height) of a set of mosaic piece options consisting of 25 different grey tones. The three large rectangular squares (21), (22) and (23) each cover an area of 40 by 50 pieces (width by height), which corresponds to a mosaic “transparent or translucent mounting base” size disclosed in this application. This displayed mosaic pattern of Drawing B requires the use of three 40 by 50 piece mosaic mounting bases, joined horizontally in portrait orientation.

Image (24) shows the piece-segregated pattern for all pieces of a specific light-grey color, depicting a black small rectangular square at each precise mosaic piece location of that specific light-grey color. For example, dashed line (27) demonstrates the full-scale transposition of some specific light-grey color mosaic piece positions from design (20) onto piece-segregated pattern image (24).

Image (25) shows the piece-segregated pattern for all pieces of a specific mid-grey color, depicting a black small rectangular square at each precise mosaic piece location of that specific mid-grey color. For example, dashed line (28) demonstrates the full-scale transposition of some specific mid-grey color mosaic piece positions from design (20) onto piece-segregated pattern image (25).

Image (26) shows the piece-segregated pattern for all pieces of a specific dark-grey color, depicting a black small rectangular square at each precise mosaic piece location of that specific dark-grey color. For example, dashed line (29) demonstrates the full-scale transposition of some specific dark-grey color mosaic piece positions from design (20) onto piece-segregated pattern image (26).

Each image (24), (25) and (26) further shows three large portrait-oriented rectangular squares, each corresponding to the size of a single mosaic mounting base.

Drawing C

“Drawing C” depicts a top view of a transparent mounting base (30) full-scale. The dots represent individual mosaic piece placement positions. The base (30) is sized 40 by 50 mosaic piece positions.

Drawing D

“Drawing D” depicts the top right corner of the transparent or translucent mounting base (30) in close up. Here we see the top right fifteen mosaic piece positions, each consisting of a small pin (31).

Drawing E

“Drawing E” depicts a side view of the mounting base (30) in close up. Here we see the most right five mosaic piece positions, each consisting of a small pin (31).

Drawing F

“Drawing F” depicts a single transparent mounting being placed on top of piece-segregated pattern (41).

Drawing G

“Drawing G” depicts the precise fit, where a single transparent mounting base (30) is precisely overlying a piece-segregated pattern (41).

### MODE(S) FOR CARRYING OUT THE INVENTION

The invented method can be carried out in the (home) crafts production of a reproduction of an image or (graphic) design, in mosaic.

The method can be carried out in the production of a reproduction of an image or (graphic) design, in mosaic, outside the (home) crafts sector. For example, for the purpose of producing mosaic displays for use by legal entities (commercial, enterprises, museums, government, or other). Displays may represent expressions of images, text, textures or other, with the object of information dissemination, marketing, decoration or other. The invented manufacturer is specifically designed for use in conjunction with the modes for carrying out the invented method, as described immediately above.

The method can be used to produce a reproduction of an image or (graphic) design, in color painting and/or drawing and/or etching and/or other technique, on a transparent or translucent underground or base.

The method can be used to produce a reproduction of ant image or (graphic) design, in (ceramic or other) tile on a wall, floor, or any other surface.

The method can be used to produce a reproduction of an image or (graphic) design, in stained glass or stained glass look alike.

Other modes of usage or applications for the method of producing a mosaic reproduction of an image or (graphic) design, using piece-segregated patterns underneath a transparent or translucent mosaic mounting base, will become apparent from a consideration of the invention description and drawings.

Other modes of usage or applications for the manufacturer, the mosaic mounting base (30), will become apparent from a consideration of the invention description and drawings.

I claim:

1. A method of producing a mosaic reproduction of an image or (graphic) design in conjunction with a transparent mosaic mounting base, comprising the steps of:
a. selecting a piece-segregated pattern out of a collection of piece-segregated patterns comprising a mosaic reproduction, and
b. placing the selected pattern underneath a transparent mosaic mounting base in accordance with specified placement instructions, and
c. applying on the said base an individual mosaic piece of a mosaic piece option specified by the said pattern at a position indicated by the said pattern, and
d. repeating the said applying until individual mosaic pieces have been positioned at all specified positions indicated by the said pattern, and
e. repeating steps a, b, c and d until all mosaic pieces comprising the said reproduction have been applied.

2. The method of claim 1 wherein the said pattern is depicted on a tangible material.

3. The method of claim 1 wherein the said pattern is displayed on an electronic display.

4. The method of claim 3 wherein the said display also functions as the said mosaic mounting base.

5. The method of claim 1 wherein the said pattern is visually projected onto a mosaic mounting base, using a means for projection.

6. The method of claim 1 wherein the said pattern graphically displays the mosaic piece positions, in full-scale, of a specific mosaic piece option.

7. The method of claim 1 wherein the said pattern graphically displays the mosaic piece positions, in full-scale, of a limited set of mosaic piece options.

8. The method of claim 1 wherein the said mosaic piece is made out of synthetic material.

9. The method of claim 1 wherein said mosaic pieces are manufactured in a color corresponding to mosaic piece options required for a mosaic reproduction.

10. The method of claim 1 wherein the said mosaic piece length and width equal between 1.0 and 3.0 millimeters, in relation to the said piece natural orientation on the said base.

11. The method of claim 1 wherein the said mosaic piece length and width equal 2.54 nmillimeters±25 percent, in relation to the said piece natural orientation on the said base.

12. The method of claim 1 wherein the said base consists of 40 by 50 mosaic piece positions orderly distributed at equal x-axis and y-axis distance between the center points of adjacent mosaic piece positions.

13. The method of claim 1 wherein the said base width equals 101.6 millimeters and the said base length equals 127.0 millimeters±20 percent.

14. The method of claim 1 wherein the distance between the center points of the majority of adjacent mosaic piece positions equals 2.54 millimeters±50 percent.

15. The method of claim 1 wherein the said base is translucent.

16. A mosaic mounting base, whereof:
a. mosaic piece positions are orderly distributed in rows, and
b. the said mosaic piece positions each constitute of pins which allow for the mounting of a mosaic piece, and
c. the distance between the center points of the majority of adjacent mosaic piece positions measured along the said rows is constant, and
d. the said base transparency allows for reading of a piece-segregated pattern positioned underneath the said base.

17. The manufacturer of claim 16 whereof the said mosaic piece positions each constitute of a means to mount a mosaic piece.

18. The manufacturer of claim 16 whereof the number of mosaic piece positions is 40 by 50 equals a total of 2000, ±50 percent

19. The manufacturer of claim 16 whereof the said distance equals 2.54 millimeters, ±10 percent.

20. The manufacturer of claim 16 whereof the said base is translucent.
